(19) United States
(12) Patent Application Publication
(10) Pub. No.: US 2026/0358663 A1
(43) Pub. Date: Nov. 12, 2026

(54) LIQUID CRYSTAL LIGHT CONTROL DEVICE, IMAGING DEVICE, AND ADAPTER DEVICE

(71) Applicant: SONY GROUP CORPORATION, TOKYO (JP)

(72) Inventors: YUTARO TANOUE, TOKYO (JP); KENTA SEKI, TOKYO (JP); YASUHIRO MATSUI, TOKYO (JP); YOSHINORI SUGIYAMA, TOKYO (JP); SHOTA IWAMOTO, TOKYO (JP)

(21) Appl. No.: 19/111,901

(22) PCT Filed: Aug. 8, 2023
(86) PCT No.: PCT/JP2023/028867

§ 371 Date: Mar. 14, 2025

(30) Foreign Application Priority Data
Sep. 22, 2022 (JP) 2022-151501

(51) Int. Cl. G02F 1/1341; G02F 1/1339; G03B 11/00

(52) U.S. Cl. CPC G02F 1/1341; G02F 1/1339; G03B 11/00

(57) ABSTRACT

A liquid crystal is uniformly dispersed as much as possible without unevenness in a liquid crystal injection layer.

A liquid crystal light control device includes a liquid crystal injection port configured to inject liquid crystal into a liquid crystal injection layer surrounded by a seal portion, and an asymmetry forming portion configured to impart asymmetry regarding inflow of the liquid crystal in a plurality of inflow paths extending from the liquid crystal injection port.

### TECHNICAL FIELD

The present disclosure relates to a liquid crystal light control device, an imaging device, and an adapter device.

### BACKGROUND ART

Imaging devices widely used as digital still cameras, video cameras, and the like include a lens and an imaging element provided on an optical axis of the lens. Then, in some imaging devices, a liquid crystal light control device used as a neutral density (ND) filter is provided between a lens and an imaging element. With this liquid crystal light control device, it is possible to adjust the amount of light from the lens toward the imaging element. The following Patent Document 1 discloses a liquid crystal light control device that can be applied to an imaging device. Furthermore, Patent Document 2 below discloses a liquid crystal display element formed by injecting liquid crystal from an opening portion provided in a seal portion.

### CITATION LIST

### Patent Document

Patent Document 1: International Publication No. 2020/195177
Patent Document 2: Japanese Patent Application Laid-Open No. 6-34984

### SUMMARY OF THE INVENTION

### Problems to be Solved by the Invention

In this field, it is desired that the liquid crystal is uniformly dispersed as much as possible without unevenness in the liquid crystal injection layer into which the liquid crystal is injected.

An object of the present disclosure is to provide a liquid crystal light control device, an imaging device, and an adapter device capable of uniformly dispersing a liquid crystal as much as possible without unevenness in a liquid crystal injection layer into which the liquid crystal is injected.

### Solutions to Problems

The present disclosure provides, for example,
a liquid crystal light control device including:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

The present disclosure provides, for example,
an imaging device including:
an imaging element;
a liquid crystal light control unit; and
a light control drive unit that drives the liquid crystal light control unit, in which
the liquid crystal light control unit includes:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

The present disclosure provides, for example,
an adapter device including:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

### BRIEF DESCRIPTION OF DRAWINGS

FIG. 1 is a diagram referred to when problems to be considered in the present disclosure is described.

FIG. 2 is a diagram referred to when problems to be considered in the present disclosure is described.

A to D of FIG. 3 is a diagram referred to when problems to be considered in the present disclosure is described.

FIG. 4 is an exploded perspective view of a liquid crystal light control device according to an embodiment.

FIG. 5 is a cross-sectional view of a liquid crystal light control device according to an embodiment.

FIG. 6 is a diagram referred to when a shape example of an asymmetry forming portion according to an embodiment.

A and B of FIG. 7 are partially enlarged views of FIG. 6.

FIG. 8 is a diagram referred to when an action of an asymmetry forming portion according to an embodiment.

FIG. 9 is a diagram referred to when an action of an asymmetry forming portion according to an embodiment.

FIG. 10 is a diagram referred to when the liquid crystal injection step is described.

A to D of FIG. 11 are diagrams referred to when an example of an effect obtained by the liquid crystal light control device according to an embodiment is described.

FIG. 12 is a diagram referred to when an application example of the liquid crystal light control device according to an embodiment to the imaging device is described.

FIG. 13 is a diagram referred to when an application example of the liquid crystal light control device according to an embodiment to the imaging device is described.

A and B of FIG. 14 are diagrams referred to when an application example of the liquid crystal light control device according to an embodiment to the imaging device is described.

FIG. 15 is a diagram referred to when an application example of the liquid crystal light control device according to an embodiment to the imaging device is described.

FIG. 16 is a diagram referred to when an application example of the liquid crystal light control device according to an embodiment to the imaging device is described.

FIG. 17 is a diagram for describing a modification.

FIG. 18 is a diagram for describing a modification.

### MODE FOR CARRYING OUT THE INVENTION

Hereinafter, an embodiment and the like of the present disclosure will be described with reference to the drawings. Note that the description is given in the following order.

### Problems to be Considered in the Present Disclosure

### One Embodiment

### Modifications

An embodiment and the like described below are preferred specific examples of the present disclosure, and the content of the present disclosure is not limited to the embodiment and the like.

### Problems to be Considered in the Present Disclosure

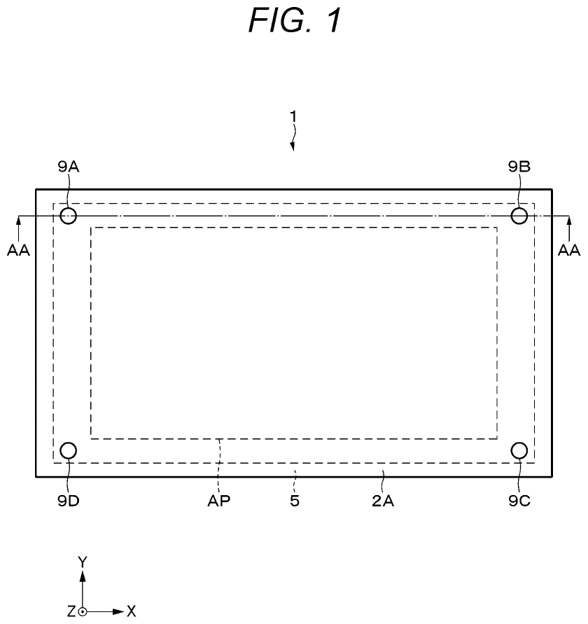

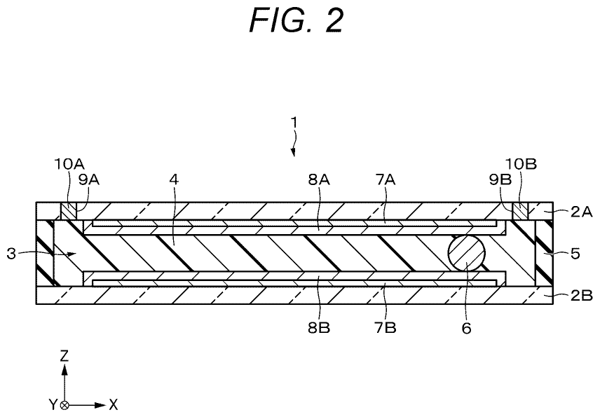

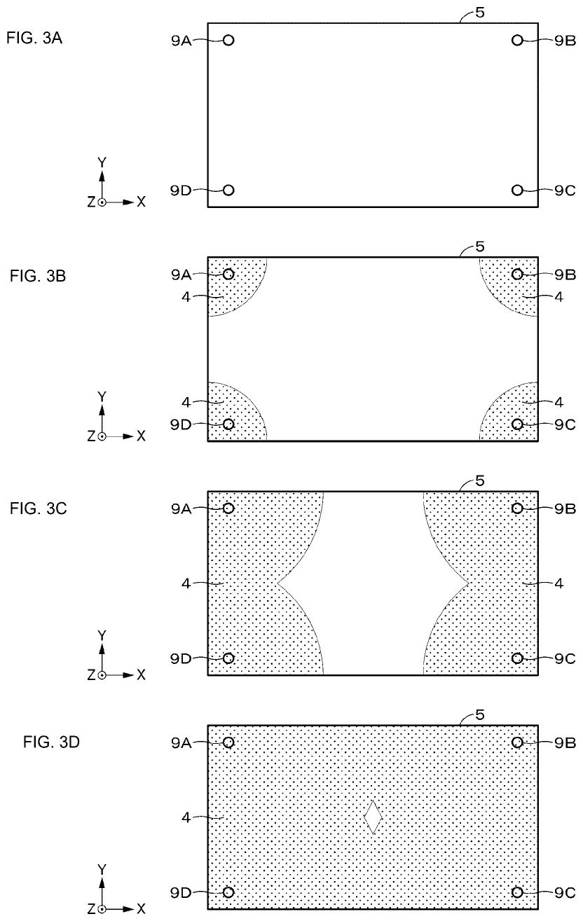

First, problems to be considered in the present disclosure will be described in order to facilitate understanding of the present disclosure. FIG. 1 is a plan view of a general liquid crystal light control device (liquid crystal light control device 1). FIG. 2 is a cross-sectional view of the liquid crystal light control device 1 taken along line AA-AA in FIG. 1. The liquid crystal light control device 1 can be used, for example, as an ND filter of an imaging device. Note that, in the following description, a horizontal direction (left-right direction) in FIG. 1 is an X direction, a vertical direction (up-down direction) is a Y direction, and a direction toward a paper surface (thickness direction) is a Z direction.

The liquid crystal light control device 1 includes an upper glass substrate 2A and a lower glass substrate 2B arranged to face each other. A facing gap between the upper glass substrate 2A and the lower glass substrate 2B serves as a liquid crystal injection layer 3 into which liquid crystal is injected (filled), and the liquid crystal (liquid crystal composition) 4 is injected into the liquid crystal injection layer 3. The peripheral edge of the liquid crystal injection layer 3 is sealed by a seal portion 5. Furthermore, in the liquid crystal injection layer 3, a bead-shaped spacer 6 is disposed in order to secure the facing gap between the upper glass substrate 2A and the lower glass substrate 2B.

On the main surface of the upper glass substrate 2A on the liquid crystal injection layer 3 side, a conductive film 7A and an alignment film 8A are stacked in this order in the −Z direction. Furthermore, on the main surface of the lower glass substrate 2B on the liquid crystal injection layer 3 side, a conductive film 7B and an alignment film 8B are stacked in this order in the +Z direction. The amount of light passing through the liquid crystal light control device 1 is controlled by controlling the drive voltage applied to the conductive films 7A and 7B.

Liquid crystal injection ports 9A, 9B, 9C, and 9D, which are hole portions for injecting liquid crystal into the liquid crystal injection layer 3, are provided near the four corners of the upper glass substrate 2A. Note that, in a case where it is not necessary to distinguish the individual liquid crystal injection ports, the liquid crystal injection ports are appropriately collectively referred to as a liquid crystal injection port 9. The liquid crystal injection port 9 communicates with the liquid crystal injection layer 3, and the liquid crystal 4 is injected into the liquid crystal injection layer 3 through the liquid crystal injection port 9. After the injection of the liquid crystal 4, the liquid crystal injection port 9 is closed by a plug. For example, the liquid crystal injection port 9A is closed by a plug 10A, and the liquid crystal injection port 9B is closed by plug 10B. Note that, in this example, the number of the liquid crystal injection ports 10 is 4, but may be 1, 2, or 5 or more.

In the in-plane direction (XY direction) of the liquid crystal injection layer 3, an effective light control area AP is defined in the filling region of the liquid crystal 4 surrounded by the seal portion 5 (see FIG. 1). The effective light control area AP is a region that ensures effective light control, and is defined as a region narrower than the entire filling region of the liquid crystal 4.

Such a general liquid crystal light control device 1 has the following problems. For example, in a case where the liquid crystal injection layer 3 includes a plurality of layers and the alignment directions of the liquid crystals of the liquid crystal injection layers 3 are orthogonal to each other, it is necessary to stack a plurality of the configurations illustrated in FIG. 2, and thus there is a problem that the thickness of the liquid crystal light control device 1 increases.

Furthermore, in a case where the liquid crystal is injected through the liquid crystal injection port 9 provided outside the effective light control area AP, the flow rate of the liquid crystal 4 near the liquid crystal injection port 9 (near the four corners of the effective light control area AP) increases. Therefore, the alignment films 8A and 8B are damaged, and there is a problem that white spots in which the alignment films 8A and 8B are peeled off and in-plane unevenness of the liquid crystal 4 easily occur.

FIGS. 3A to 3D are schematic views illustrating a step of injecting the liquid crystal 4 into the liquid crystal injection layer 3 in time series. Note that, in FIGS. 3A to 3D, a part of the configuration is illustrated in a simplified manner, and the liquid crystal 4 is illustrated with dots. FIG. 3A is a diagram illustrating the liquid crystal 4 before injection. Then, the liquid crystal 4 is injected through the liquid crystal injection port 9. As illustrated in FIGS. 3B and 3C, the liquid crystal injection layer 3 is gradually filled with the liquid crystal 4 from the four corners where the liquid crystal injection port 9 is provided. Then, as illustrated in FIG. 3D, the flow of the liquid crystal 4 finally converges to the vicinity of the center of the effective light control area AP. When the flow of the liquid crystal 4 converges in the vicinity of the center as described above, there is a problem that the residual gas in the spacer 6 and the liquid crystal injection layer 3 may gather in the vicinity of the center. Furthermore, there is a problem that there is a high possibility that an image quality problem such as generation of bright spots occurs due to aggregation of the spacer 6 in the vicinity of the center.

Furthermore, in the technique described in Patent Document 2 described above, since the liquid crystal is injected through the opening provided in the seal portion, it is necessary to provide an opening in each layer of the seal portion in a case where the liquid crystal injection layer includes a plurality of layers. Therefore, since it is necessary to inject the liquid crystal for each of the plurality of liquid crystal injection layers, the step may be complicated. Furthermore, in the technique described in Patent Document 2, since the inflow path of the liquid crystal starting from the liquid crystal injection port is bilaterally symmetrical, there is a possibility that the load on the alignment film at the time of liquid crystal injection cannot be effectively reduced. Based on the above points, one embodiment of the present disclosure will be described in detail.

### One Embodiment

### Configuration Example of Liquid Crystal Light Control Device

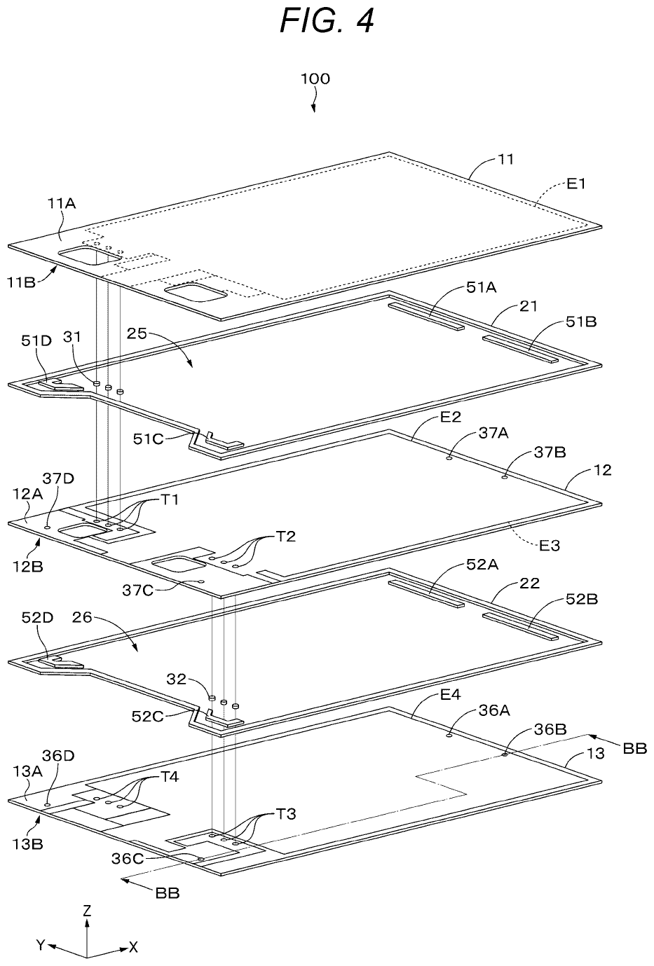

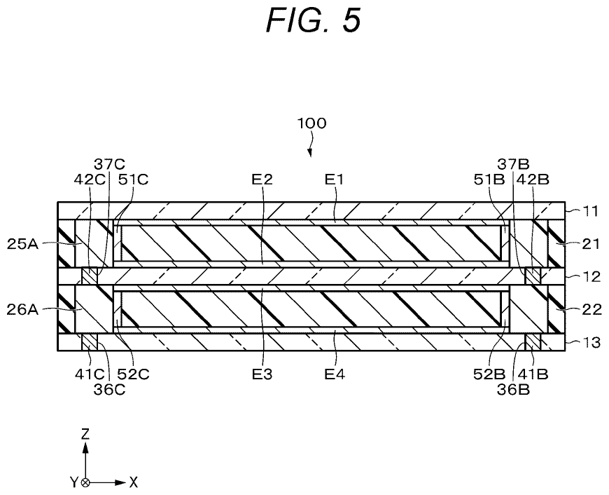

First, a configuration example of a liquid crystal light control device (liquid crystal light control device 100) according to the present embodiment will be described with reference to FIGS. 4 and 5. FIG. 4 is an exploded perspective view of the liquid crystal light control device 100. FIG. 5 is a cross-sectional view illustrating a cross section in a case where the liquid crystal light control device 100 is cut along a cutting line BB-BB in FIG. 4. Note that, in the following description, a surface located on the +Z direction side of each component is referred to as a front surface or an upper surface, and a surface located on the −Z direction side is referred to as a back surface or a lower surface.

As illustrated in FIG. 4, the liquid crystal light control device 100 has a configuration in which, for example, an upper substrate 11, a first seal portion 21, a middle substrate 12, a second seal portion 22, and a lower substrate 13 are stacked in this order from the top. That is, the first seal portion 21 is interposed between the upper substrate 11 and the middle substrate 12, and the second seal portion 22 is interposed between the middle substrate 12 and the lower substrate 13. A region surrounded by the first seal portion 21 (a region inside the first seal portion 21) is a first liquid crystal injection layer 25 into which liquid crystal is injected. The liquid crystal is injected into the first liquid crystal injection layer 25 to form a first liquid crystal layer 25A (see FIG. 5). A region surrounded by the second seal portion 22 (a region inside the second seal portion 22) is a second liquid crystal injection layer 26 into which liquid crystal is injected. The liquid crystal is injected into the second liquid crystal injection layer 26 to form a second liquid crystal layer 26A (see FIG. 5).

In the present exemplary embodiment, GH liquid crystal (guest-host liquid crystal) is used as liquid crystal constituting the first liquid crystal layer 25A and the second liquid crystal layer 26A. By arranging the liquid crystal alignment between the two liquid crystal layers in the crossed Nicols arrangement, it is possible to improve the image quality when the liquid crystal light control device 100 is applied to the imaging device.

The upper substrate 11, the middle substrate 12, and the lower substrate 13 are glass substrates for partitioning the first liquid crystal layer 25A and the second liquid crystal layer 26A. The upper substrate 11 is a substrate disposed on the uppermost side, the lower substrate 13 is a substrate disposed on the lowermost side, and the middle substrate 12 is a glass substrate disposed between the upper substrate 11 and the lower substrate 13.

The upper substrate 11 and the middle substrate 12 are joined by the first seal portion 21. For example, the vicinity of the peripheral edge of the upper substrate 11 and the vicinity of the peripheral edge of the middle substrate 12 are joined by the first seal portion 21. Furthermore, the middle substrate 12 and the lower substrate 13 are joined by the second seal portion 22. For example, the vicinity of the peripheral edge of the middle substrate 12 and the vicinity of the peripheral edge of the lower substrate 13 are joined by the second seal portion 22. As the first seal portion 21 and the second seal portion 22, for example, an adhesive such as an epoxy adhesive or an acrylic adhesive is used.

As described above, in the present embodiment, the liquid crystal layer included in the liquid crystal light control device 100 includes two layers (first liquid crystal layer 25A and second liquid crystal layer 26A). In correspondence with such a configuration, a total of four electrodes including two electrodes as counter electrodes with respect to one liquid crystal layer and two electrodes as counter electrodes with respect to the other liquid crystal layer are formed, and accordingly, four terminals are also formed. As the electrode, for example, indium tin oxide (ITO) can be used. An AR (Anti Reflection) film stacked on the ITO may be used.

Specifically, a first electrode E1 is formed on a back surface 11B side of the upper substrate 11. Furthermore, a first terminal T1 corresponding to the first electrode E1 is formed on a front surface 12A side of the middle substrate 12. Furthermore, a second terminal T2 is a terminal corresponding to the second electrode E2 formed on the front surface 12A side of the middle substrate 12. The second terminal T2 is a terminal formed as a part of the second electrode E2 formed on the front surface 12A side of the same middle substrate 12. Note that there is a gap in the thickness direction (Z direction) between the first electrode E1 formed on the upper substrate 11 and the first terminal T1 formed on the middle substrate 12. Therefore, a silver point 31 electrically connecting the first terminal T1 and the first electrode E1 is provided between the upper substrate 11 and the middle substrate 12.

Furthermore, a third terminal T3 is a terminal corresponding to a third electrode E3 formed on a back surface 12B side of the middle substrate 12, and a fourth terminal T4 is a terminal corresponding to a fourth electrode E4 formed on a front surface 13A side of the lower substrate 13. The fourth terminal T4 is formed as a part of the fourth electrode E4 formed on the front surface 13A side of the same lower substrate 13. Note that there is a gap in the thickness direction of the liquid crystal light control device 100 between the third terminal T3 formed on the lower substrate 13 and the third electrode E3 formed on the middle substrate 12. Therefore, a silver point 32 electrically connecting the third terminal T3 and the third electrode E3 is provided between the middle substrate 12 and the lower substrate 13. As the silver points 31 and 32, for example, conductive carbon or the like is used. Note that, in FIG. 5, illustration of the alignment film stacked on each of the first electrode E1, the second electrode E2, the third electrode E3, and the fourth electrode E4 and the spacer arranged between the substrates is omitted in order to prevent the illustration from being complicated.

A connector (not illustrated) with a cable is connected to the first terminal T1, the second terminal T2, the third terminal T3, and the fourth terminal T4. A liquid crystal drive signal SP1 is supplied to the set of the first terminal T1 and the second terminal T2 via the connector with cable. The alignment of the liquid crystal constituting the first liquid crystal layer 25A is controlled by the liquid crystal drive signal SP1. Furthermore, a liquid crystal drive signal SP2 is supplied to the set of the third terminal T3 and the fourth terminal T4. The alignment of the liquid crystal constituting the second liquid crystal layer 26A is controlled by the liquid crystal drive signal SP2.

A liquid crystal injection port 36 for injecting liquid crystal into the first liquid crystal injection layer 25 and the second liquid crystal injection layer 26 is formed in the lower substrate 13. In the present embodiment, the liquid crystal injection port 36 includes four liquid crystal injection ports 36A, 36B, 36C, and 36D. The four liquid crystal injection ports are provided at positions of the lower substrate 13 corresponding to positions near the four corners of the second liquid crystal injection layer 26 in a plan view of the second liquid crystal injection layer 26. Note that, in a case where it is not necessary to distinguish the four liquid crystal injection ports, the four liquid crystal injection ports are appropriately collectively referred to as a liquid crystal injection port 36.

A liquid crystal injection port 37 for injecting liquid crystal into the first liquid crystal injection layer 25 is formed in the middle substrate 12. In the present embodiment, the liquid crystal injection port 37 includes four liquid crystal injection ports 37A, 37B, 37C, and 37D. The four liquid crystal injection ports are provided at positions of the middle substrate 12 corresponding to positions near the four corners of the first liquid crystal injection layer 25 in a plan view of the first liquid crystal injection layer 25. Note that, in a case where it is not necessary to distinguish the four liquid crystal injection ports, the four liquid crystal injection ports are appropriately collectively referred to as a liquid crystal injection port 37.

The liquid crystal injection port 36 penetrates the lower substrate 13, and the liquid crystal injection port 37 penetrates the middle substrate 12. In the present embodiment, the liquid crystal injection port 36 and the liquid crystal injection port 37 are formed in the same shape and the same size. Furthermore, these liquid crystal injection ports are arranged such that the formation positions overlap each other in the in-plane direction, in other words, the formation positions overlap each other in the thickness direction (Z direction and stacking direction of the first liquid crystal injection layer 25 and the second liquid crystal injection layer 26). Specifically, the formation positions of the liquid crystal injection port 36A and the liquid crystal injection port 37A in the in-plane direction and the thickness direction overlap with each other. Furthermore, the formation positions of the liquid crystal injection port 36B and the liquid crystal injection port 37B in the in-plane direction and the thickness direction overlap with each other. Furthermore, the formation positions of the liquid crystal injection port 36C and the liquid crystal injection port 37C in the in-plane direction and the thickness direction overlap with each other. Furthermore, the formation positions of the liquid crystal injection port 36D and the liquid crystal injection port 37D in the in-plane direction and the thickness direction overlap with each other. The liquid crystal injection port 37 located between the layers communicates with the first liquid crystal injection layer 25 and the second liquid crystal injection layer 26.

Although details will be described later, liquid crystal is injected into the first liquid crystal injection layer 25 and the second liquid crystal injection layer 26 through the liquid crystal injection port 36 and the liquid crystal injection port 37. After the liquid crystal injection, the liquid crystal injection port 36 is closed by a plug 41. Specifically, the liquid crystal injection ports 36A to 36D are closed by corresponding plugs 41A to 41D, respectively (see FIG. 5).

Furthermore, after the liquid crystal injection, the liquid crystal injection port 37 is closed by a plug 42. Specifically, the liquid crystal injection ports 37A to 37D are closed by corresponding plugs 42A to 42D, respectively (see FIG. 5). The plug 41 and the plug 42 are the same plug, and for example, a cured adhesive can be used.

Note that the components included in the liquid crystal light control device 100 described above are merely examples, and the liquid crystal light control device 100 may include components other than the components described above. For example, in FIG. 4, a region protruding in the −X direction in each electrode may be used as a monitoring region of optical density. A connector on which a sensor for detecting optical density is mounted may be connected to the monitoring area.

### Asymmetry Forming Portion

### Shape Example

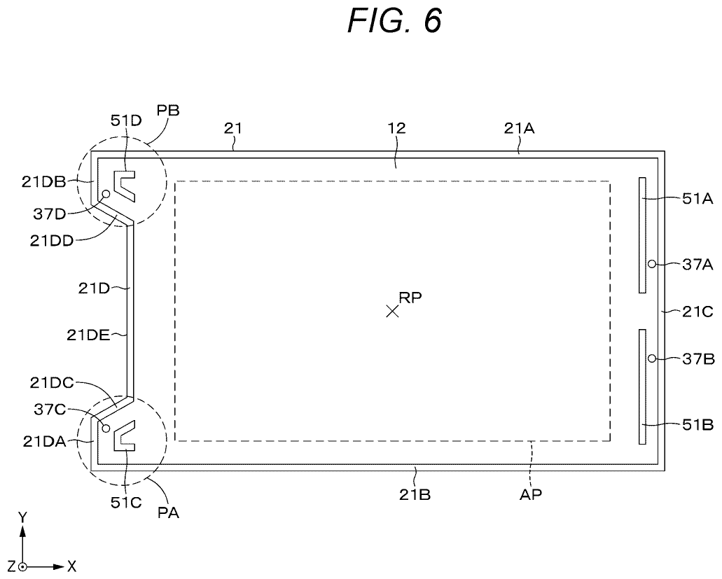

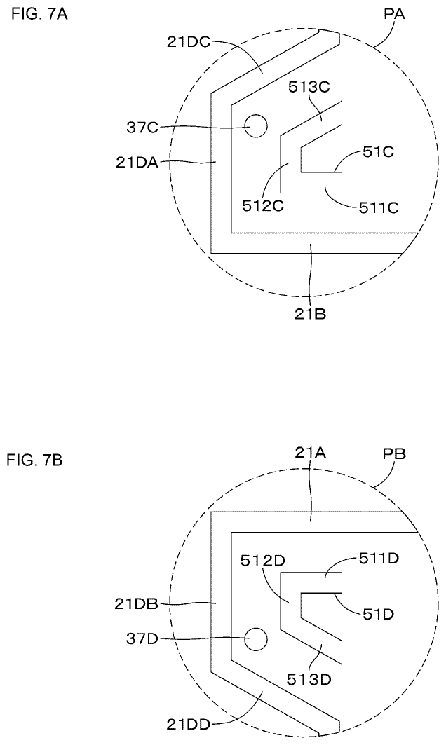

Moreover, an example of the asymmetry forming portion included in the liquid crystal light control device 100 will be described with reference to FIGS. 6 and 7. FIG. 6 is a plan view of the front surface 12A of the middle substrate 12 on which the first seal portion 21 is formed. FIG. 7A is a partially enlarged view enlarging a portion surrounded by dotted line PA in FIG. 6, and FIG. 7B is a partially enlarged view enlarging a portion surrounded by dotted line PB in FIG. 6.

As illustrated in FIG. 6, the first seal portion 21 schematically has a frame shape. An effective light control area AP is defined in the area surrounded by the first seal portion 21. The effective light control area AP is a region that ensures effective light control, and is defined as a region narrower than the entire liquid crystal filling region in the first liquid crystal injection layer 25. A reference position RP is set substantially at the center of the effective light control area AP. Note that the reference position RP can be set at an appropriate position different from the substantially center of the effective light control area AP. Furthermore, although not illustrated, the effective light control area AP is also defined in an area surrounded by the second seal portion 22.

Specifically, the first seal portion 21 includes a first side portion 21A, a second side portion 21B facing the first side portion 21A, a third side portion 21C connecting the first side portion 21A and the second side portion 21B, and a fourth side portion 21D facing the third side portion 21C. The first side portion 21A, the second side portion 21B, and the third side portion 21C are straight side portions. Furthermore, the fourth side portion 21D includes straight portions 21DA and 22DB extending from the respective ends, a bent portion 21DC that is bent in an obliquely upward direction from a tip end of the straight portion 21DA toward the inside, a bent portion 21DD that is bent in an obliquely downward direction from a tip end of the straight portion 22DB toward the inside, and a straight portion 21DE that connects a tip end of the bent portion 21DC and a tip end of the bent portion 21DD.

The asymmetry forming portion is for imparting asymmetry regarding inflow of the liquid crystal in a plurality of inflow paths of the liquid crystal extending from the liquid crystal injection port. In the present embodiment, the asymmetry forming portion includes a first wall portion 51 and a second wall portion 61. The first wall portion 51 contains the same material as the first seal portion 21 and is formed by the same step. Therefore, the manufacturing step of the liquid crystal light control device 100 can be simplified. The second wall portion 52 contains the same material as the second seal portion 22 and is formed by the same step. Therefore, the manufacturing step of the liquid crystal light control device 100 can be simplified.

A shape example of the first wall portion 51 will be described. The first wall portion 51 includes a wall portion 51A and a wall portion 51B provided outside and on the right side of the effective light control area AP, a wall portion 51C provided outside the effective light control area AP and near the lower left corner, and a wall portion 51D provided outside the effective light control area AP and near the upper left corner.

The wall portion 51A is a wall portion substantially parallel to the third side portion 21C. The liquid crystal injection port 37A is provided between the lower part of the wall portion 51A and the third side portion 21C. The wall portion 51B is a wall portion substantially parallel to the third side portion 21C. The liquid crystal injection port 37B is provided between the upper part of the wall portion 51B and the third side portion 21C.

The wall portion 51C has a substantially C shape. Specifically, as illustrated in FIG. 7A, the wall portion 51C includes a wall portion 511C substantially parallel to the second side portion 21B, a wall portion 512C substantially parallel to the straight portion 21DA, and a wall portion 513C substantially parallel to the bent portion 21DC. Then, the wall portions 511C, 512C, and 513C are integrally connected to form the wall portion 51C. The liquid crystal injection port 37C is provided between the vicinity of the boundary between the straight portion 21DA and the bent portion 21DC and the vicinity of the boundary between the wall portion 512C and the wall portion 513C.

The wall portion 51D has a substantially C shape. Specifically, as illustrated in FIG. 7B, the wall portion 51D includes a wall portion 511D substantially parallel to the first side portion 21A, a wall portion 512D substantially parallel to the straight portion 22DB, and a wall portion 513D substantially parallel to the bent portion 21DD. Then, the wall portions 511D, 512D, and 513D are integrally connected to form the wall portion 51D. The liquid crystal injection port 37D is provided between the vicinity of the boundary between the straight portion 22DB and the bent portion 21DD and the vicinity of the boundary between the wall portion 512D and the wall portion 513D.

Note that, in the present embodiment, the shapes of the first wall portion 51 and the second wall portion 52 are substantially the same. Therefore, the above description is also applicable to the second wall portion 52. Note that this does not exclude that the first wall portion 51 and the second wall portion 52 have a difference in configuration.

A configuration example of the second wall portion 52 will be schematically described with reference to FIG. 4. The second wall portion 52 includes a wall portion 52A having a shape similar to the wall portion 51A, a wall portion 52B having a shape similar to the wall portion 51B, a wall portion 52C having the shape similar to the wall portion 51C, and a wall portion 52D having the shape similar to the wall portion 51D. In the present embodiment, the first seal portion 21 and the second seal portion 22 constitute a seal portion.

### Operations

Next, the operations of the asymmetry forming portion according to the present embodiment will be described. The wall portion 51A constituting the asymmetry forming portion imparts asymmetry regarding the inflow of the liquid crystal in the plurality of inflow paths of the liquid crystal which extend from the liquid crystal injection port 37A. Here, the asymmetry regarding the inflow of the liquid crystal is, for example, a difference in the length (for example, the shortest distance) of the inflow path from the liquid crystal injection port 37A to the reference position, and the reference position is, for example, substantially at the center of the effective light control area AP set in the first seal portion 21 (the above-described reference position RP).

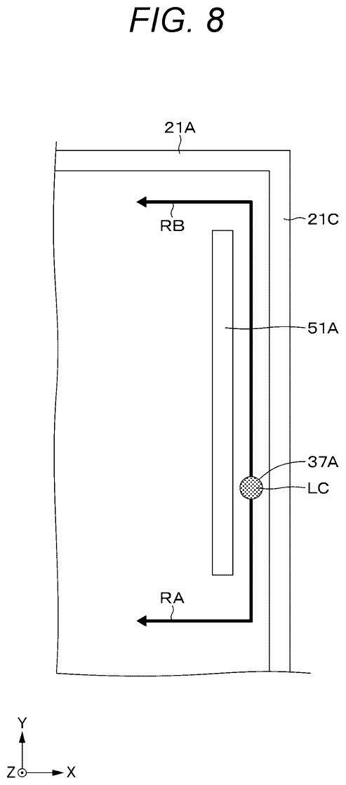

As illustrated in FIG. 8, liquid crystal LC is injected from the liquid crystal injection port 37A. The inflow path of the liquid crystal LC in the first liquid crystal injection layer 25 is branched into two by the wall portion 51A, and two inflow paths starting from the liquid crystal injection port 37A are formed. For example, an inflow path RA having a small (short) length from the liquid crystal injection port 37A to the reference position RP and an inflow path RB having a large (long) length from the liquid crystal injection port 37A to the reference position RP are formed. Similarly, two inflow paths having different lengths through which the liquid crystal LC injected from the liquid crystal injection port 37B flows are also formed by the wall portion 51B.

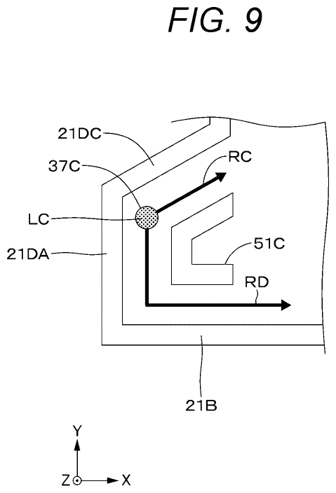

Two inflow paths of the liquid crystal LC having different lengths are also formed by the wall portion 51C. As illustrated in FIG. 9, the liquid crystal LC is injected from the liquid crystal injection port 37C. The inflow path of the liquid crystal LC in the first liquid crystal injection layer 25 is branched into two by the wall portion 51C, and two inflow paths starting from the liquid crystal injection port 37C are formed. For example, an inflow path RC having a small (short) length from the liquid crystal injection port 37C to the reference position RP and an inflow path RD having a large (long) length from the liquid crystal injection port 37C to the reference position RP are formed. Similarly, two inflow paths having different lengths through which the liquid crystal LC injected from the liquid crystal injection port 37D flows are also formed by the wall portion 51D.

### Example of Manufacturing Method of Liquid Crystal Light Control Device

Next, an example of a method for manufacturing the liquid crystal light control device 100 according to the present embodiment will be described. First, the upper substrate 11, the middle substrate 12, and the lower substrate 13 are prepared. The first electrode E1 is formed on the back surface 11B of the upper substrate 11. Furthermore, the second electrode E2 is formed on the front surface 12A of the middle substrate 12, and the third electrode E3 is formed on the back surface 12B. Furthermore, the fourth electrode E4 is formed on the front surface 13A of the lower substrate 13. For example, each electrode is formed by patterning a transparent conductive film with a laser.

Next, the liquid crystal injection port 36 is formed in the lower substrate 13, and the liquid crystal injection port 37 is formed in the middle substrate 12. For example, the liquid crystal injection port 36 and the liquid crystal injection port 37 are formed by laser drilling.

Next, a step of forming a seal portion is performed. For example, the first seal portion 21 is formed on the back surface 11B of the upper substrate 11. At this time, the first wall portion 51 is also formed at the same time. Furthermore, the second seal portion 22 is formed on the front surface 13A of the lower substrate 13. At this time, the second wall portion 52 is also formed at the same time. For example, the first seal portion 21, the second seal portion 22, the first wall portion 51, and the second wall portion 52 (hereinafter, appropriately collectively referred to as the first seal portion 21 and the like) are formed by a screen printing method. As a material of the first seal portion 21 and the like, for example, a thermosetting resin such as an epoxy resin is used.

Subsequently, the silver point 31 is formed on the back surface 11B side of the upper substrate 11, and the silver point 32 is formed on the back surface 12B of the middle substrate 12. For example, the silver points 31 and 32 are formed by applying conductive carbon.

Next, a spacer scattering step is performed. For example, the glass spheres are scattered on the back surface 11B side of the upper substrate 11 and the front surface 12A side of the middle substrate 12. In this example, for example, a liquid (for example, ethanol) containing glass spheres having a diameter of 7 μm is scattered by a spraying method or the like.

Next, the upper substrate 11 and the middle substrate 12 are bonded together by the first seal portion 21, and the middle substrate 12 and the lower substrate 13 are bonded together by the second seal portion 22. In the present embodiment, since the thermosetting resin is used as the material of the first seal portion 21 and the second seal portion 22, the bonding step is performed by heating and pressurizing the upper substrate 11, the middle substrate 12, and the lower substrate 13 after the alignment. By this step, the peripheral edge of the first liquid crystal injection layer 25 is sealed by the first seal portion 21, and the first wall portion 51 is disposed in the first liquid crystal injection layer 25. Furthermore, the peripheral edge of the second liquid crystal injection layer 26 is sealed by the second seal portion 22, and the first wall portion 52 is disposed in the second liquid crystal injection layer 26.

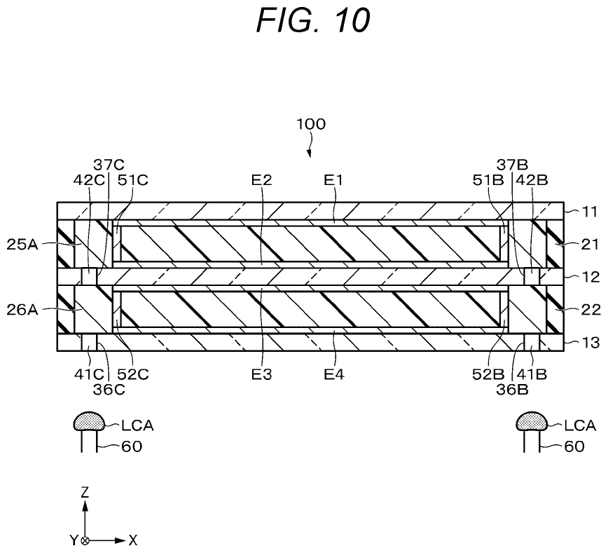

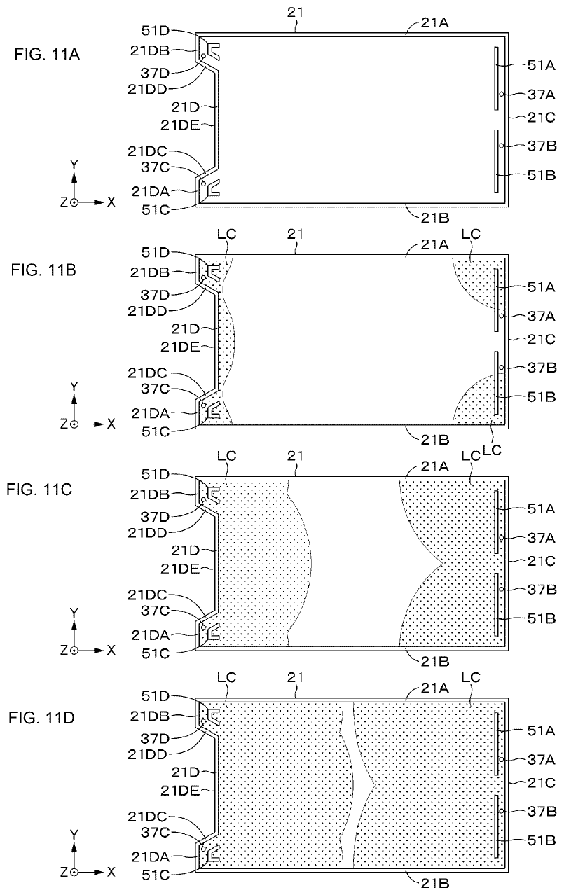

Next, the liquid crystal LC is injected into the first liquid crystal injection layer 25 and the second liquid crystal injection layer 26 through the liquid crystal injection port 36 and the liquid crystal injection port 37. As illustrated in the schematic diagram of FIG. 10, the liquid crystal LC is injected using a liquid crystal drop LCA including the liquid crystal LC placed on a predetermined jig 60. Specifically, in the present example, the tip end portion of the liquid crystal drop LCA which is placed on the jig 60 and on which surface tension acts is brought into contact with the liquid crystal injection port 36 to inject the liquid crystal LC. The injection of the liquid crystal LC in this case is performed using a capillary phenomenon. Note that the injection of the liquid crystal LC into the four liquid crystal injection ports (liquid crystal injection ports 36A to 36D) is performed simultaneously, for example.

The liquid crystal LC injected from the liquid crystal injection port 36 is filled not only to the second liquid crystal injection layer 26 formed between the lower substrate 13 and the middle substrate 12 but also to the first liquid crystal injection layer 25 formed between the middle substrate 12 and the upper substrate 11 via the liquid crystal injection port 37. Here, by injecting the liquid crystal by bringing the tip end portion of the liquid crystal drop LCA on which the surface tension acts as described above into contact with the liquid crystal injection port 36, the liquid crystal hardly leaks to the outside of the liquid crystal injection port 36, and the use efficiency of the liquid crystal LC is improved. Since the positions of the liquid crystal injection port 36 and the liquid crystal injection port 37 in the in-plane direction, particularly the center positions overlap, the liquid crystal LC injected from the liquid crystal injection port 36 is easily injected into the liquid crystal layer (first liquid crystal injection layer 25) on the back side through the liquid crystal injection port 37, and the time required for the liquid crystal injection step can be shortened.

After completion of the filling of the liquid crystal LC, the liquid crystal injection port 36 is closed by the plug 41, and the liquid crystal injection port 37 is closed by the plug 42. Specifically, in the present example, the liquid crystal is sucked through the liquid crystal injection port 36 in a state where the liquid crystal LC filled is expanded by heating, and an adhesive such as an ultraviolet curable resin as the plugs 41 and 42 is injected through the liquid crystal injection port 36 into the gap formed by the sucking. Thereafter, as the filled liquid crystal LC cools, the injected adhesive is drawn into the liquid crystal injection port 37, whereby the liquid crystal injection port 36 and the liquid crystal injection port 37 are closed, and the liquid crystal LC is sealed.

Next, the connector with cable is attached to each terminal or each electrode to complete the liquid crystal light control device 100. Note that the above-described manufacturing method is an example, and the order of some steps may be changed.

### Effects Obtained by Present Embodiment

In the liquid crystal light control device according to the present embodiment, the inflow paths (flow paths) of liquid crystal having different lengths in two directions from the liquid crystal injection ports are formed by the asymmetry forming portion. Therefore, the wear load on the alignment film in the vicinity of the liquid crystal injection port can be effectively reduced as compared with the shape having only one inflow path from one liquid crystal injection port (see FIG. 2). Therefore, this makes it possible to reduce the occurrence of defects such as in-plane unevenness and white spot caused by wear of the alignment film.

Furthermore, at the time of injecting the liquid crystal into the first liquid crystal injection layer or the second liquid crystal injection layer, the liquid crystal easily flows along the outer edge (the first seal portion or the second seal portion), so that the inflow speed of the liquid crystal LC is basically higher on the outer edge side (seal side). In the present embodiment, two paths extending from one liquid crystal injection port are a short inflow path (for example, the inflow paths RA and RC described above) on the central side of the effective light control area and a long inflow path (for example, the inflow paths RB and RD described above) on the outer edge side. As described above, by imparting asymmetry to the length of the inflow path in consideration of the inflow speed of the liquid crystal, it is possible to realize a liquid crystal inflow wavefront that is substantially parallel. FIGS. 11A to 11D are diagrams schematically illustrating a step in which the liquid crystal LC (illustrated with dots) spreads in the first liquid crystal injection layer 25 (or the second liquid crystal injection layer 26) in the present embodiment.

FIG. 11A illustrates a state before injection of the liquid crystal LC. The edges of the liquid crystal LC from each liquid crystal injection port are substantially at the same position in the X direction (FIG. 11B), and finally, the edges of the liquid crystal LC propagating laterally become substantially parallel (FIGS. 11C and 11D). Therefore, as described with reference to FIG. 3, it is possible to reduce a risk of aggregation of the spacer and the residual gas in the vicinity of the center and a risk of generation of bright spots caused by these, and it is possible to realize improvement of the strength and reliability of the liquid crystal light control device in addition to improvement of image quality. Furthermore, the liquid crystal LC can be uniformly dispersed as much as possible without unevenness in the in-plane direction of the liquid crystal injection layer into which the liquid crystal LC is injected.

Furthermore, according to the liquid crystal light control device according to the present embodiment, in a case where a plurality of liquid crystal layers (for example, two layers) is provided, the number of substrates may be three as compared with a configuration in which two layers of substrates and a liquid crystal layer filled between the substrates are stacked, and thus the entire liquid crystal light control device can be downsized. Furthermore, since the liquid crystal injection step may be performed only once without performing a plurality of liquid crystal injection steps, the manufacturing step can be simplified.

### Application Example to Imaging Device

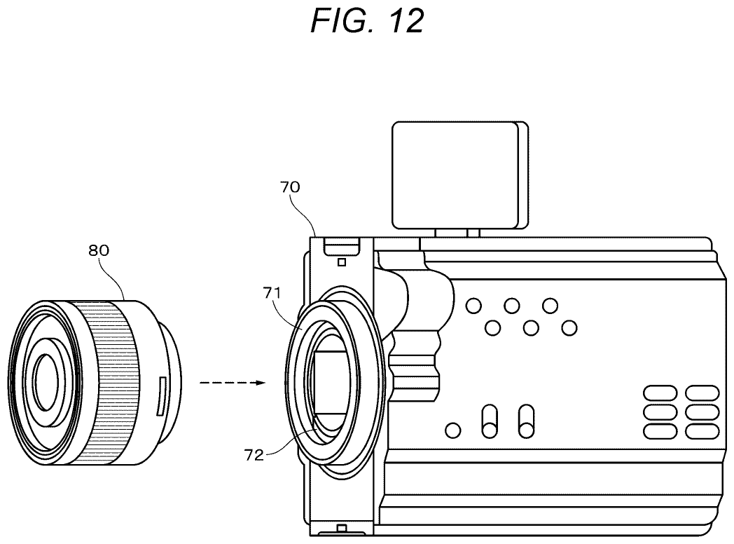

The liquid crystal light control device 100 according to the present embodiment is applicable to, for example, an imaging device. An application example of the liquid crystal light control device 100 to an imaging device will be described with reference to FIGS. 12 to 16.

FIG. 12 illustrates an imaging device 70 and a lens barrel 80 as one of interchangeable lenses detachably attachable to the imaging device 70. The external shapes of the imaging device 70 and the lens barrel 80 illustrated in the drawing are merely examples. As one type of the present embodiment, a lens-interchangeable video camera or a digital still camera is assumed.

As illustrated in the drawing, a mount portion 71 for the lens barrel 80 is formed in the imaging device 70, and the lens barrel 80 can be detachably attached to the imaging device 70 via the mount portion 71. Furthermore, a terminal 72 is formed in the mount portion 71. The lens barrel 80 corresponding to the imaging device 70 is provided with electrical contacts that come into contact with the respective electrical contacts of the terminal 72 in a mounted state to the imaging device 70, and a transmission path of various electrical signals is formed between the imaging device 70 and the lens barrel 80 by this contact state.

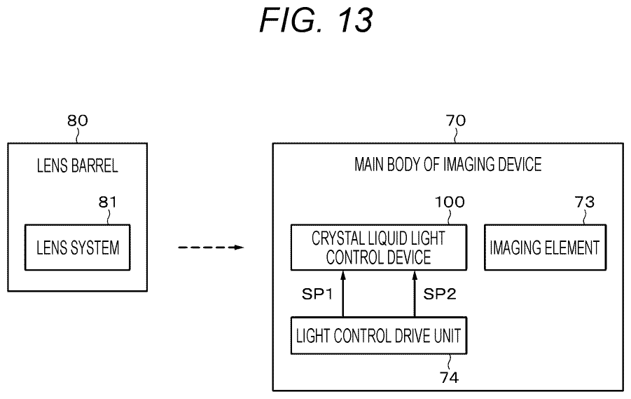

FIG. 13 schematically illustrates that the liquid crystal light control device 100, an imaging element 73, and a light control drive unit 74 that drives the liquid crystal light control device 100 are arranged in the camera body of the imaging device 70. The light control drive unit 74 provides the liquid crystal drive signals SP1 and SP2 to each liquid crystal layer in the liquid crystal light control device 100 to control the transmittance of each liquid crystal layer. The imaging element 73 is configured as, for example, a charge coupled device (CCD) type, a complementary metal oxide semiconductor (CMOS) type, or the like. A lens system 81 including optical components such as a plurality of lenses including a zoom lens and a focus lens is provided on the lens barrel 80 side. In the configuration example of FIG. 13, when the lens barrel 80 is attached to the imaging device 70, incident light via the lens system 81 is adjusted by the liquid crystal light control device 100 on the imaging device 70 side and received by the imaging element 73.

FIG. 14A illustrates an example in which the lens system 81, the liquid crystal light control device 100, and the light control drive unit 74 are arranged on the lens barrel 80 side, and the imaging element 73 is arranged on the main body side of the imaging device 70. Also in this case, when the lens barrel 80 is attached to the imaging device 70, incident light via the lens system 81 is adjusted by the liquid crystal light control device 100 and is received by the imaging element 73.

FIG. 14B illustrates an example in which the lens system 81 and the liquid crystal light control device 100 are arranged on the lens barrel 80 side, and the imaging element 73 and the light control drive unit 74 are arranged on the main body side of the imaging device 70. In the present example, when the lens barrel 80 is attached to the imaging device 70, the liquid crystal drive signals SP1 and SP2 from the light control drive unit 74 are supplied to the liquid crystal light control device 100.

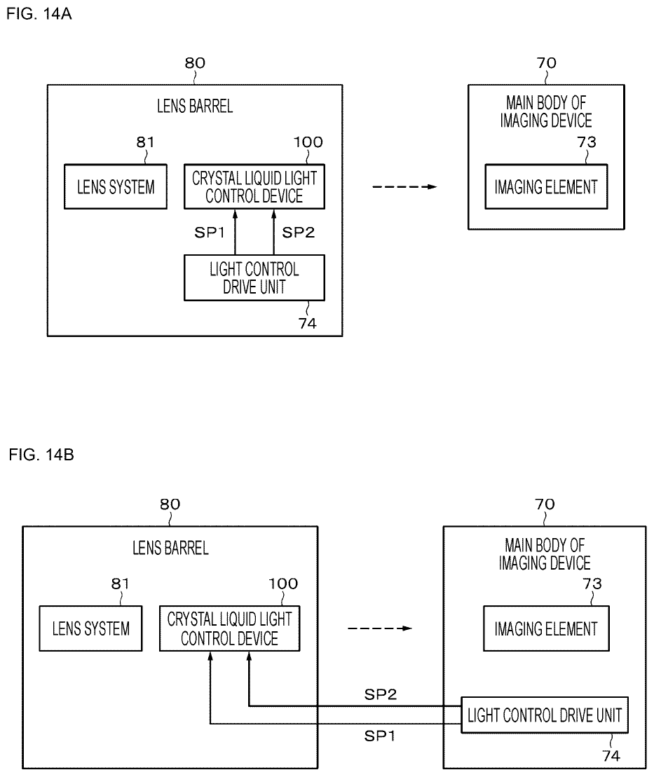

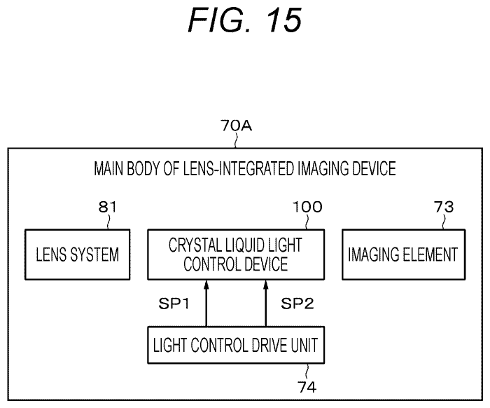

FIG. 15 illustrates a case of a lens-integrated imaging device 70A that is not an interchangeable lens type, and such a lens-integrated imaging device 70A is also one type of the present embodiment. Of course, in this case, the lens system 81, the liquid crystal light control device 100, the imaging element 73, and the light control drive unit 74 are all disposed in the main body of the imaging device 70A.

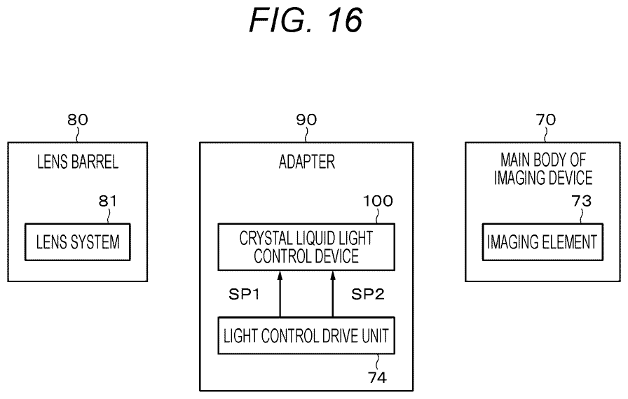

FIG. 16 illustrates an example in which the liquid crystal light control device 100 and the light control drive unit 74 are incorporated in an adapter device 90. As schematically illustrated in FIG. 16, the adapter device 90 is disposed so as to be interposed between the imaging device 70 and the lens barrel 80. The adapter device 90 is detachable from both the imaging device 70 and the lens barrel 80. As described above, the present disclosure can also be realized as the adapter device 90 including the liquid crystal light control device 100 as the liquid crystal light control unit. Note that, in the case of the configuration example illustrated in FIG. 16, the light control drive unit 74 may be in the lens barrel 80 or the imaging device 70.

### Modifications

Although the embodiment of the present disclosure has been specifically described above, the present disclosure is not limited to the above-described one embodiment, and various modifications based on the technical idea of the present disclosure are possible.

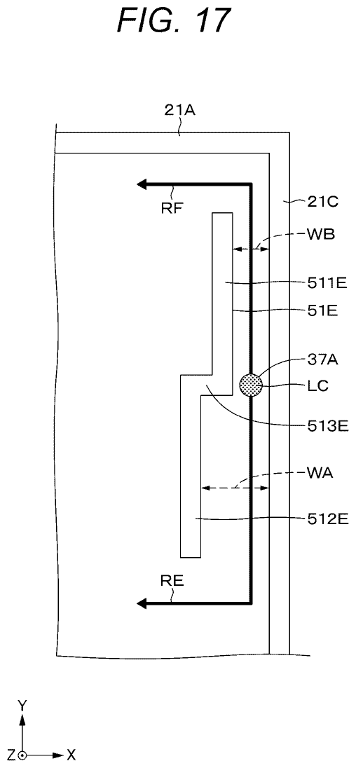

The shape of the wall portion of the asymmetry forming portion can be changed as appropriate. For example, the shape may be a shape of a wall portion (wall portion 51E) illustrated in FIG. 17. The wall portion 51E includes, for example, a wall portion 511E substantially parallel to the third side portion 21C, a wall portion 512E located inside the wall portion 511E and substantially parallel to the third side portion 21C, and a connecting portion 513E substantially parallel to the first side portion 21A and connecting the wall portion 511E and the wall portion 512E. The liquid crystal injection port 37A is provided between the connecting portion 513E and the third side portion 21C (substantially at the center of the wall portion 51E in the Y direction).

The wall portion 51E forms an inflow path RE and an inflow path RF as inflow paths of the liquid crystal LC. In this example, a width WA (length in the X direction) of the inflow path RE is different from a width WB (length in the X direction) of the inflow path RF. For example, the width WA is set to be larger than the width WB. As described above, the asymmetry regarding the inflow of the liquid crystal may be a difference in width for each inflow path. The difference between the width WA and the width WB causes a difference between the flow speed of the liquid crystal LC flowing through the inflow path RE and the flow speed of the liquid crystal LC flowing through the inflow path RF. Specifically, the flow speed of the liquid crystal LC flowing through the inflow path RF is faster than the flow speed of the liquid crystal LC flowing through the inflow path RE. As described above, from another viewpoint, the asymmetry regarding the inflow of the liquid crystal may be a difference in the flow speed of the liquid crystal flowing through the inflow path. Furthermore, the difference between the width WA and the width WB causes a difference between the flow rate of the liquid crystal LC flowing through the inflow path RE (for example, the flow rate of the liquid crystal LC flowing per unit time) and the flow rate of the liquid crystal LC flowing through the inflow path RF. Specifically, the flow rate of the liquid crystal LC flowing through the inflow path RE is larger than the flow rate of the liquid crystal LC flowing through the inflow path RF. As described above, from another viewpoint, the asymmetry regarding the inflow of the liquid crystal may be a difference in the flow rate of the liquid crystal flowing through the inflow path.

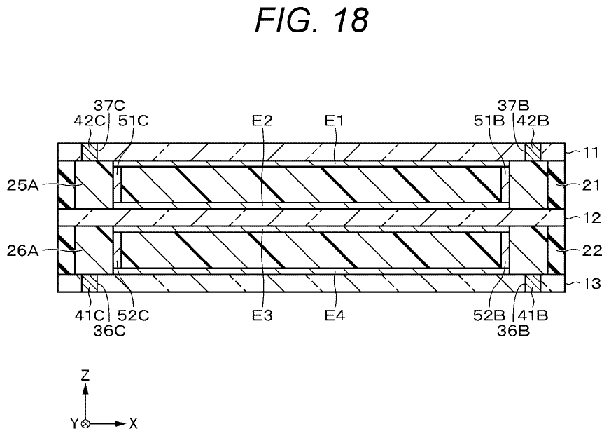

In the above-described embodiment, the liquid crystal is injected into the first liquid crystal injection layer and the second liquid crystal injection layer from the same direction (lower substrate side), but the liquid crystal may be injected into the first liquid crystal injection layer and the second liquid crystal injection layer from different directions. For example, as illustrated in FIG. 18, the liquid crystal injection port 37 is provided in the upper substrate 11. Then, the liquid crystal is injected into the first liquid crystal injection layer 25 from a front surface 11A side of the upper substrate 11 (upward direction (an example of the first direction) ) through the liquid crystal injection port 37. As in the embodiment, the liquid crystal is injected into the second liquid crystal injection layer 26 from a back surface 13B side (downward direction (an example of the second direction) ) of the lower substrate 13 through the liquid crystal injection port 36. According to this configuration, the liquid crystal can be more uniformly dispersed in the first liquid crystal injection layer 25 as compared with the configuration in which the liquid crystal is injected through the liquid crystal injection port between the layers.

In the above-described embodiment, the liquid crystal layers are two of the first liquid crystal layer and the second liquid crystal layer, but may be one or three or more. The number of seal portions may be other than two. Furthermore, although two inflow paths of the liquid crystal are formed by the wall portion which is an example of the asymmetry forming portion, three or more inflow paths may be formed. Furthermore, in the above-described embodiment, the configuration example in which the asymmetry forming portion includes eight wall portions (four wall portions of the first wall portion 51 and four wall portions of the second wall portion 52) has been described. However, some of the eight wall portions may be the asymmetry forming portion, and the number of wall portions may be other than eight. Furthermore, the shape of the wall portion can also be changed as appropriate. Furthermore, the asymmetry forming portion may be a recess provided in the middle substrate or the lower substrate instead of the wall portion, and the recess may impart asymmetry regarding the inflow of the liquid crystal. The liquid crystal light control device is also applicable to applications other than the ND filter.

The liquid crystal light control device described in the above-described embodiment may have another component. For example, the liquid crystal light control device may include a set of polarizing plates provided on the front surface side of the upper substrate and the back surface side of the lower substrate.

The configurations, the methods, the steps, the shapes, the materials, the numerical values, and the like described in the embodiment and modifications are merely examples, and a configuration, a method, a step, a shape, a material, a numerical value, and the like that are different from those in the above-described embodiment may also be used as necessary. Furthermore, the materials exemplified in the embodiment and modifications described above may be used alone or in combination of two or more unless otherwise specified. Furthermore, the components described in the embodiment and the modifications can be appropriately combined.

Note that advantageous effects described in the present description are merely examples and are not limited, and other advantageous effects may be provided.

The present disclosure may have the following configurations.

(1)

A liquid crystal light control device including:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.
   (2)

The liquid crystal light control device according to (1), in which
the asymmetry regarding the inflow of the liquid crystal is a difference in length of the inflow path from the liquid crystal injection port to a reference position.
   (3)

The liquid crystal light control device according to (2), in which
the reference position is substantially a center of an effective light control area set in the seal portion.
   (4)

The liquid crystal light control device according to (1), in which
the asymmetry regarding the inflow of the liquid crystal is a difference in flow speed of the liquid crystal flowing through the inflow path.
   (5)

The liquid crystal light control device according to (1), in which
the asymmetry regarding the inflow of the liquid crystal is a difference in width for each inflow path.
   (6)

The liquid crystal light control device according to (1), in which
the asymmetry regarding the inflow of the liquid crystal is a difference in flow rate of the liquid crystal flowing through the inflow path.
   (7)

The liquid crystal light control device according to any one of (1) to (6), in which
a plurality of the liquid crystal injection layers is stacked, and
a plurality of the liquid crystal injection ports for the plurality of liquid crystal injection layers is arranged to overlap each other along a stacking direction of the liquid crystal injection layers.
   (8)

The liquid crystal light control device according to (7), in which
a liquid crystal injection port for injecting liquid crystal from a first direction into the liquid crystal injection layer disposed on a lower side is formed, and
a liquid crystal injection port for injecting liquid crystal from a second direction opposite to the first direction into the liquid crystal injection layer disposed on an upper side is formed.
   (9)

The liquid crystal light control device according to any one of (1) to (8), in which
the asymmetry forming portion is a wall portion substantially parallel to the seal portion.
   (10)

The liquid crystal light control device according to any one of (1) to (9), in which
the asymmetry forming portion has a shape in which a plurality of wall portions substantially parallel to the seal portion is connected by a connecting portion.
   (11)

The liquid crystal light control device according to any one of (1) to (10), in which
the asymmetry forming portion forms two of the inflow paths starting from the liquid crystal injection port.
   (12)

The liquid crystal light control device according to any one of (1) to (11), in which
the asymmetry forming portion contains a same material as the seal portion.
   (13)

The liquid crystal light control device according to any one of (1) to (12), in which
the liquid crystal injection port is sealed with a plug.
   (14)

An imaging device including:
an imaging element;
a liquid crystal light control unit; and
a light control drive unit that drives the liquid crystal light control unit, in which
the liquid crystal light control unit includes:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.
   (15)

An adapter device including:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

### REFERENCE SIGNS LIST

11 Upper substrate
12 Middle substrate
13 Lower substrate
21 First seal portion
22 Second seal portion
36A, 36B, 36C, 36D Liquid crystal injection port
37A, 37B, 37C, 37D Liquid crystal injection port
51 First wall portion
51A, 51B, 51C, 51D Wall portion
52 Second wall portion
52A,, 52B, 52C, 52D Wall portion
73 Imaging element
100 Liquid crystal light control device
AP Effective light control area
LC Liquid crystal
RA, RB, RC, RD, RE, RF Inflow path
RP Reference position

1. A liquid crystal light control device comprising:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

2. The liquid crystal light control device according to claim 1, wherein
the asymmetry regarding the inflow of the liquid crystal is a difference in length of the inflow path from the liquid crystal injection port to a reference position.

3. The liquid crystal light control device according to claim 2, wherein
the reference position is substantially a center of an effective light control area set in the seal portion.

4. The liquid crystal light control device according to claim 1, wherein
the asymmetry regarding the inflow of the liquid crystal is a difference in flow speed of the liquid crystal flowing through the inflow path.

5. The liquid crystal light control device according to claim 1, wherein
the asymmetry regarding the inflow of the liquid crystal is a difference in width for each inflow path.

6. The liquid crystal light control device according to claim 1, wherein
the asymmetry regarding the inflow of the liquid crystal is a difference in flow rate of the liquid crystal flowing through the inflow path.

7. The liquid crystal light control device according to claim 1, wherein
a plurality of the liquid crystal injection layers is stacked, and
a plurality of the liquid crystal injection ports for the plurality of liquid crystal injection layers is arranged to overlap each other along a stacking direction of the liquid crystal injection layers.

8. The liquid crystal light control device according to claim 7, wherein
a liquid crystal injection port for injecting liquid crystal from a first direction into the liquid crystal injection layer disposed on a lower side is formed, and
a liquid crystal injection port for injecting liquid crystal from a second direction opposite to the first direction into the liquid crystal injection layer disposed on an upper side is formed.

9. The liquid crystal light control device according to claim 1, wherein
the asymmetry forming portion is a wall portion substantially parallel to the seal portion.

10. The liquid crystal light control device according to claim 1, wherein
the asymmetry forming portion has a shape in which a plurality of wall portions substantially parallel to the seal portion is connected by a connecting portion.

11. The liquid crystal light control device according to claim 1, wherein
the asymmetry forming portion forms two of the inflow paths starting from the liquid crystal injection port.

12. The liquid crystal light control device according to claim 1, wherein
the asymmetry forming portion contains a same material as the seal portion.

13. The liquid crystal light control device according to claim 1, wherein
the liquid crystal injection port is sealed with a plug.

14. An imaging device comprising:
an imaging element;
a liquid crystal light control unit; and
a light control drive unit that drives the liquid crystal light control unit, wherein
the liquid crystal light control unit includes:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.

15. An adapter device comprising:
a liquid crystal injection port configured to inject liquid crystal into a liquid crystal injection layer surrounded by a seal portion; and
an asymmetry forming portion configured to impart asymmetry regarding inflow of the liquid crystal in a plurality of inflow paths extending from the liquid crystal injection port.
